(19) United States
(12) Patent Application Publication
(10) Pub. No.: US 2021/0162916 A1
(43) Pub. Date: Jun. 3, 2021

(54) VEHICLE LIGHT-PROJECTION CONTROLLING DEVICE, VEHICLE LIGHT-PROJECTION SYSTEM, AND VEHICLE LIGHT-PROJECTION CONTROLLING METHOD

(71) Applicant: MAZDA MOTOR CORPORATION, Hiroshima (JP)

(72) Inventors: Takahito IKENOUCHI, Aki-gun (JP); Kota YUCHI, Aki-gun (JP)

(73) Assignee: MAZDA MOTOR CORPORATION, Hiroshima (JP)

(21) Appl. No.: 17/102,451

(22) Filed: Nov. 24, 2020

(30) Foreign Application Priority Data
Dec. 3, 2019 (JP) 2019-218533

(51) Int. Cl. B60Q 1/14; B60Q 1/00

(52) U.S. Cl. CPC B60Q 1/143; B60Q 1/0023; B60Q 2300/45; B60Q 2300/134; B60Q 2300/112

(57) ABSTRACT

The present disclosure relates to a vehicle light-projection controlling device that enhances an antiglare effect on a driver of a vehicle in a case in which a reflection body is contained in a light projection range of a light projecting unit mounted on the vehicle.

### CROSS REFERENCE TO RELATED APPLICATION

The present application is based on and claims priority of Japanese Patent Application No. 2019-218533 filed on Dec. 3, 2019, the entire contents of which are incorporated herein by reference.

### TECHNICAL FIELD

The present disclosure relates to a vehicle light-projection controlling device, a vehicle light-projection system, and a vehicle light-projection controlling method. In particular, the disclosure relates to a vehicle light-projection controlling device, a vehicle light-projection system, and a vehicle light-projection controlling method that enhance an antiglare effect on a driver of a vehicle in a case in which a reflection body is contained in a light projection range of a light projecting unit mounted on the vehicle.

### BACKGROUND

Patent document 1 described below discloses a light projection controlling method of a vehicle headlight relating to the background art. In this method, in a case in which a reflection body is contained in an image that is obtained by photographing forward of a vehicle, and brightness of the reflection body in the image exceeds a predetermined specific value, light reduction control is performed on a headlight. On the other hand, in a case in which brightness of the reflection body in the image is less than the specific value, light increase control is performed on the headlight.

### PRIOR ART DOCUMENTS

### Patent Documents

[Patent document 1] European Patent No. 2127944

### SUMMARY

### Problem to be Solved

The light projection controlling method disclosed in Patent document 1 performs the light reduction control on the headlight in the case in which brightness of the reflection body in the image exceeds the specific value. This provides an antiglare effect on a driver of the vehicle.

However, performing the light reduction control causes a decrease in the intensity of reflection light that is reflected back from the reflection body to the vehicle, whereby brightness of the reflection body in the image becomes less than the specific value. Thus, the light increase control is performed on the headlight. This makes the reflection light, which is reflected back from the reflection body to the vehicle, have a high intensity again, and consequently the driver of the vehicle feels glare.

The disclosure has been made in view of these circumstances, and an object of the disclosure is to provide a vehicle light-projection controlling device, a vehicle light-projection system, and a vehicle light-projection controlling method that enhance an antiglare effect on a driver of a vehicle in a case in which a reflection body is contained in a light projection range of a light projecting unit mounted on the vehicle.

In one aspect, a vehicle light-projection controlling device according to an aspect of the disclosure is configured to control a light projecting unit that is mounted on a vehicle. The vehicle light-projection controlling device includes a measuring unit, an estimating unit, and a light reduction controlling unit. The measuring unit is configured to measure a reference location that is a location of a reflection body relative to the vehicle. The reflection body is contained in an image that is obtained by photographing in an advancing direction of the vehicle. The estimating unit is configured to estimate a relative location of the reflection body relative to the vehicle that advances, on the basis of location information relating to the reference location and advancing information of the vehicle. The light reduction controlling unit is configured to perform light reduction control on the light projecting unit so as to reduce light to be projected to a range corresponding to the relative location, in a light projection range of the light projecting unit.

In this aspect, the measuring unit measures the reference location that is the location of the reflection body, which is contained in the image obtained by photographing in the advancing direction of the vehicle, relative to the vehicle. The estimating unit estimates the relative location of the reflection body relative to the vehicle that advances, on the basis of the location information relating to the reference location and the advancing information of the vehicle. The light reduction controlling unit performs the light reduction control on the light projecting unit so as to reduce light to be projected to the range corresponding to the relative location, in the light projection range of the light projecting unit. Thus, even when a high brightness region corresponding to the reflection body is not contained in the photographic image due to the light reduction control, the estimating unit estimates the relative location of the reflection body relative to the vehicle that advances, thereby enabling the light reduction controlling unit to continue the light reduction control with respect to the relative location, instead of canceling the light reduction control. This enhances an antiglare effect on a driver of the vehicle in the case in which the reflection body is contained in the light projection range of the light projecting unit mounted on the vehicle.

In the above-described aspect, the light reduction controlling unit can be configured to continue the light reduction control until the relative location goes out of a photographing range in the advancing direction of the vehicle.

This aspect makes the light reduction controlling unit continue the light reduction control until the relative location goes out of the photographing range in the advancing direction of the vehicle, whereby the antiglare effect on a driver of the vehicle is enhanced. That is, in consideration that the reflection body exists in a central visual field of a driver, who looks in the advancing direction of the vehicle, until the relative location goes out of the photographing range in accordance with advance of the vehicle, continuation of the light reduction control at least until the relative location goes out of the photographing range more reliably prevents the driver from feeling glare. The light reduction controlling unit may not continue the light reduction control after the relative location goes out of the photographing range, because the reflection body already goes out of the central visual field of the driver who looks in the advancing direction of the vehicle, and thus, the driver does not feel glare due to reflection light that is reflected back from the reflection body.

In the above-described aspect, the light reduction controlling unit can be configured to continue the light reduction control until the relative location goes out of the light projection range.

This aspect makes the light reduction controlling unit continue the light reduction control until the relative location goes out of the light projection range, whereby the antiglare effect on a driver of the vehicle is enhanced. That is, in consideration that the reflection body exists in a central visual field of a driver, who looks in the advancing direction of the vehicle, until the relative location goes out of the light projection range in accordance with advance of the vehicle, continuation of the light reduction control at least until the relative location goes out of the light projection range more reliably prevents the driver from feeling glare. The light reduction controlling unit may not continue the light reduction control after the relative location goes out of the light projection range, because the reflection body already goes out of the central visual field of the driver who looks in the advancing direction of the vehicle, and thus, the driver does not feel glare due to reflection light that is reflected back from the reflection body.

In the above-described aspect, the light reduction controlling unit can be configured to vary a degree of light reduction of the light projecting unit, on the basis of a distance between the vehicle and the reflection body.

In this aspect, the light reduction controlling unit varies the degree of light reduction of the light projecting unit, on the basis of the distance between the vehicle and the reflection body. This enables execution of appropriate light reduction control in accordance with the distance between the vehicle and the reflection body, neither too much nor too little.

In the above-described aspect, the light reduction controlling unit can be configured to increase the degree of light reduction of the light projecting unit as the distance between the vehicle and the reflection body is shorter.

In this aspect, the light reduction controlling unit increases the degree of light reduction of the light projecting unit as the distance between the vehicle and the reflection body is shorter, whereby the antiglare effect due to the light reduction control is enhanced.

In the above-described aspect, the light reduction controlling unit can be configured to vary the degree of light reduction of the light projecting unit, on the basis of dimensions of the reflection body contained in the image.

In this aspect, the light reduction controlling unit varies the degree of light reduction of the light projecting unit on the basis of the dimensions of the reflection body contained in the image. This enables execution of appropriate light reduction control in accordance with the dimensions of the reflection body contained in the image, neither too much nor too little.

In the above-described aspect, the light reduction controlling unit can be configured to increase the degree of light reduction of the light projecting unit as the dimensions of the reflection body contained in the image are larger.

In this aspect, the light reduction controlling unit increases the degree of light reduction of the light projecting unit as the dimensions of the reflection body contained in the image are larger, whereby the antiglare effect due to the light reduction control is enhanced.

In the above-described aspect, the advancing information can include speed information.

In this aspect, the estimating unit estimates the relative location of the reflection body relative to the vehicle that advances, on the basis of the location information relating to the reference location and the speed information of the vehicle. Use of the speed information of the vehicle enables appropriately estimating the relative location relative to the vehicle that travels a straight road.

In the above-described aspect, the advancing information can further include yaw rate information.

In this aspect, the estimating unit estimates the relative location of the reflection body relative to the vehicle that advances, on the basis of the location information relating to the reference location, the speed information of the vehicle, and the yaw rate information of the vehicle. Use of the speed information and the yaw rate information of the vehicle enables appropriately estimating the relative location relative to the vehicle that travels a curve as well as a straight road.

In the above-described aspect, the measuring unit can be configured to measure the reference location on the basis of map information in which a placed location of the reflection body is registered and location information showing a current location of the vehicle.

In this aspect, the measuring unit measures the reference location on the basis of the map information in which the placed location of the reflection body is registered and the location information showing a current location of the vehicle. Use of the map information in which the placed location of the reflection body is registered and the location information showing a current location of the vehicle enables exactly measuring the reference location of the reflection body.

In the above-described aspect, the estimating unit can be further configured to estimate the relative location on the basis of map information in which a placed location of the reflection body is registered and location information showing a current location of the vehicle.

In this aspect, the estimating unit estimates the relative location of the reflection body relative to the vehicle that advances, on the basis of the location information relating to the reference location, the advancing information of the vehicle, the map information in which the placed location of the reflection body is registered, and the location information showing a current location of the vehicle. Use of the map information in which the placed location of the reflection body is registered and the location information showing a current location of the vehicle enables exactly estimating the relative location.

A vehicle light-projection system according to an aspect of the disclosure includes a light projecting unit, an imaging unit, an advance measuring unit, and a light projection controlling unit. The light projecting unit is configured to project light in an advancing direction of a vehicle. The imaging unit is configured to perform photographing in the advancing direction of the vehicle. The advance measuring unit is configured to measure advancing information of the vehicle. The light projection controlling unit includes a measuring unit, an estimating unit, and a light reduction controlling unit. The measuring unit is configured to measure a reference location that is a location of a reflection body relative to the vehicle. The reflection body is contained in an image that is taken by the imaging unit. The estimating unit is configured to estimate a relative location of the reflection body relative to the vehicle that advances, on the basis of location information relating to the reference location and the advancing information measured by the advance measuring unit. The light reduction controlling unit is configured to perform light reduction control on the light projecting unit so as to reduce light to be projected to a range corresponding to the relative location, in a light projection range of the light projecting unit.

In this aspect, the measuring unit measures the reference location that is the location of the reflection body, which is contained in the image taken by the imaging unit, relative to the vehicle. The estimating unit estimates the relative location of the reflection body relative to the vehicle that advances, on the basis of the location information relating to the reference location and the advancing information measured by the advance measuring unit. The light reduction controlling unit performs the light reduction control on the light projecting unit so as to reduce light to be projected to the range corresponding to the relative location, in the light projection range of the light projecting unit. Thus, even when a high brightness region corresponding to the reflection body is not contained in the photographic image due to the light reduction control, the estimating unit estimates the relative location of the reflection body relative to the vehicle that advances, thereby enabling the light reduction controlling unit to continue the light reduction control with respect to the relative location, instead of canceling the light reduction control. This enhances an antiglare effect on a driver of the vehicle in the case in which the reflection body is contained in the light projection range of the light projecting unit mounted on the vehicle.

A vehicle light-projection controlling method according to an aspect of the disclosure controls projection of light in an advancing direction of a vehicle. The method includes measuring a reference location that is a location of a reflection body relative to the vehicle. The reflection body is contained in an image that is obtained by photographing in the advancing direction of the vehicle. The method also includes estimating a relative location of the reflection body relative to the vehicle that advances, on the basis of location information relating to the reference location and advancing information of the vehicle. The method further includes performing light reduction control so as to reduce light to be projected to a range corresponding to the relative location, in a range of projecting light in the advancing direction of the vehicle.

In this aspect, the reference location that is the location of the reflection body, which is contained in the image obtained by photographing in the advancing direction of the vehicle, is measured relative to the vehicle. Moreover, the relative location of the reflection body relative to the vehicle that advances is estimated on the basis of the location information relating to the reference location and the advancing information of the vehicle. Then, the light reduction control is performed so as to reduce light to be projected to the range corresponding to the relative location, in the range of projecting light in the advancing direction of the vehicle. Thus, even when a high brightness region corresponding to the reflection body is not contained in the photographic image due to the light reduction control, the relative location of the reflection body relative to the vehicle that advances is estimated, whereby it is possible to continue the light reduction control with respect to the relative location, instead of canceling the light reduction control. This enhances an antiglare effect on a driver of the vehicle in the case in which the reflection body is contained in the range of projecting light in the advancing direction of the vehicle.

The disclosure describes various advantages including enhancing the antiglare effect on a driver of the vehicle in the case in which a reflection body is contained in the light projection range of the light projecting unit mounted on the vehicle.

### BRIEF DESCRIPTION OF THE DRAWINGS

FIG. 1 schematically shows a state in which a vehicle detects a target that is located forward of the vehicle.

FIG. 2 A schematically shows an example of a headlight unit, and FIG. 2B schematically shows an example of an LED array.

FIG. 3 is a diagram for explaining light projection ranges of high beams.

FIG. 4R is a diagram for illustrating a light projection range of each LED element of a right high-beam unit, and FIG. 4L is a diagram for illustrating a light projection range of each LED element of a left high-beam unit.

FIG. 5 is a block diagram showing a configuration of a vehicle light-projection system.

FIG. 6 is a diagram for explaining an estimating method of a second location performed by a location estimating unit.

FIG. 7 is a flowchart showing a flow of processing executed by an ECU.

FIG. 8 schematically shows an example of a situation in which light reduction control of the high beam is executed.

FIG. 9 is a flowchart showing a flow of processing executed by the ECU.

FIG. 10 is a block diagram showing a configuration of the vehicle light-projection system.

FIG. 11 is a diagram showing an example of a relationship between a distance and a degree of light reduction.

FIG. 12 is a diagram showing an example of a relationship between an area and the degree of light reduction.

### DETAILED DESCRIPTION

Hereinafter, aspects of the disclosure will be detailed with reference to the drawings. Note that elements denoted by the same reference signs in different drawings are the same or corresponding elements.

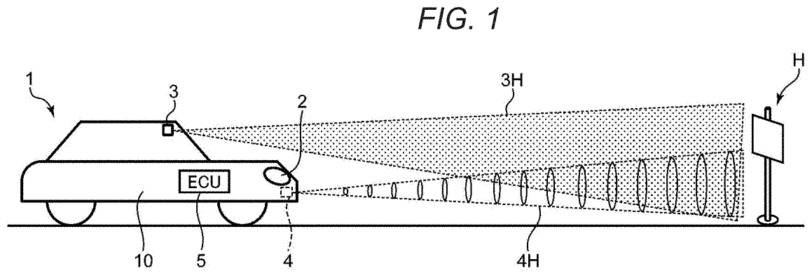

FIG. 1 schematically shows a state in which a vehicle 1 detects a target that is located forward of the vehicle 1. The vehicle 1 is, for example, a four-wheeled vehicle. The vehicle 1 includes a vehicle body 10, a headlight unit 2, a monocular camera 3, a millimeter-wave radar 4, and an electronic control unit (ECU) 5. The headlight unit 2 is mounted at a front part of the vehicle body 10 and serves as a light projecting unit. The monocular camera 3 and the millimeter-wave radar 4 serve as sensing elements for detecting a target that is located forward of the vehicle 1. The ECU 5 serves as a light projection controlling device for controlling operation of the headlight unit 2.

The headlight unit 2 has a light projecting function for projecting illumination light in an advancing direction or forward of the vehicle 1 during traveling in a situation of low illuminance, such as night. FIG. 1 shows a situation in which a road sign H as an example of a target is located forward of the vehicle 1. The road sign H is an example of a reflection body and is contained in a light projection range of the headlight unit 2. Thus, illumination light that is projected from the headlight unit 2 is reflected at the road sign H, and this reflection light reaches the vehicle 1.

The road sign H is also contained in a photographing range of the monocular camera 3. The monocular camera 3 includes an imaging sensor, such as a CMOS area sensor, and is disposed at a predetermined position of the vehicle 1, for example, at a position in the vicinity of an inner rearview mirror. The monocular camera 3 takes an image of an area forward of the vehicle 1 at a predetermined angle of view. The monocular camera 3 performs processing, e.g., photoelectric conversion, on an image obtained by light that enters the imaging sensor, including a light image 3H of the road sign H, to generate image data, and the monocular camera 3 inputs this image data to the ECU 5. The ECU 5 analyzes the received image data to measure the location of the road sign H relative to the vehicle 1 in terms of distance and angle. Details of this measurement will be described later. Instead of the monocular camera 3, for example, a stereoscopic camera may be used.

The road sign H is also contained in an emission range of the millimeter-wave radar 4. The millimeter-wave radar 4 sends a modulated radio wave in a millimeter wave band, forward of the vehicle 1 and receives a reflected wave of the modulated radio wave that is reflected back, to detect a target existing forward of the vehicle 1. The millimeter-wave radar 4 is disposed, for example, at a front end part of the vehicle body 10 in the vicinity of a front bumper. The millimeter-wave radar 4 performs processing, e.g., AD conversion, on the received reflected wave, including a reflected wave 4H from the road sign H, to generate reception data, and the millimeter-wave radar 4 inputs this reception data to the ECU 5. The ECU 5 analyzes the received reception data to measure the location of the road sign H relative to the vehicle 1 in terms of distance and angle. Details of this measurement will be described later. Instead of the millimeter-wave radar 4, for example, a laser radar may be used.

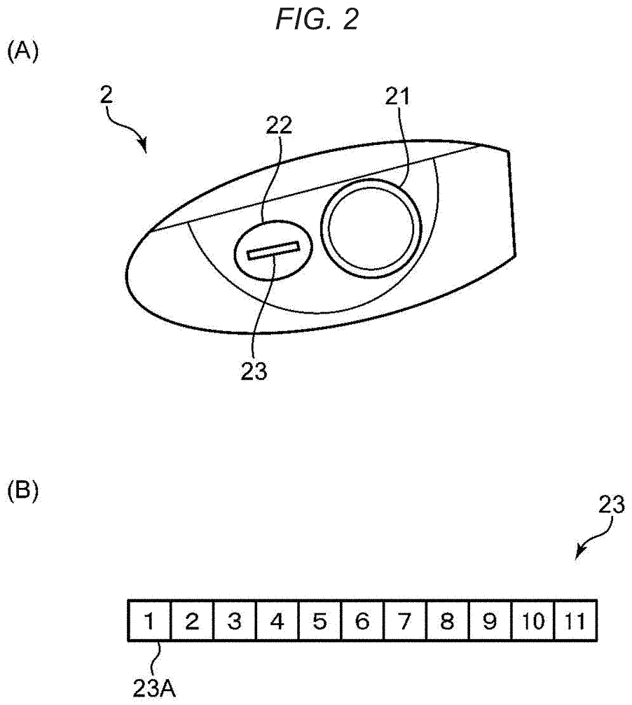

FIG. 2A schematically shows an example of the headlight unit 2. The vehicle 1 is mounted with a pair of components of the headlight unit 2 in the vicinity of right and left ends at the front part of the vehicle body 10. FIG. 2A shows only one of the components of the headlight unit 2. The headlight unit 2 includes a low beam unit 21 and a high beam unit 22.

The low beam unit 21 projects a low beam that is directed slightly lower forward of the vehicle 1. Thus, a forward area relatively close to the vehicle 1 is illuminated by the low beam. The low beam unit 21 includes an LED light source for projecting a low beam, a reflection mirror, and other parts.

The high beam unit 22 projects a high beam that is directed forward in an approximately horizontal direction of the vehicle 1. Thus, a forward area relatively distant from the vehicle 1 is illuminated by the high beam. The high beam unit 22 includes an LED array 23 as a light source for projecting a high beam.

FIG. 2B schematically shows an example of the LED array 23. The LED array 23 includes multiple LED elements 23A in which the light projection ranges or the light projection angles are different from each other, as unit light sources. FIG. 2B shows an example in which the LED element 23A is disposed in each of eleven sections that are arrayed in a line. The eleven sections have package numbers from 1 to 11 in this order from the center to the outer side of the vehicle 1. The number of the sections is any multiple number, and the number may be more or less than 11. Each of the sections contains the LED element 23A as an example of a unit light source in which the amount of light is independently controllable. The number of the LED elements 23A contained in each of the sections may be one or multiple. In addition, multiple sections may be arrayed in a matrix of M rows×N columns.

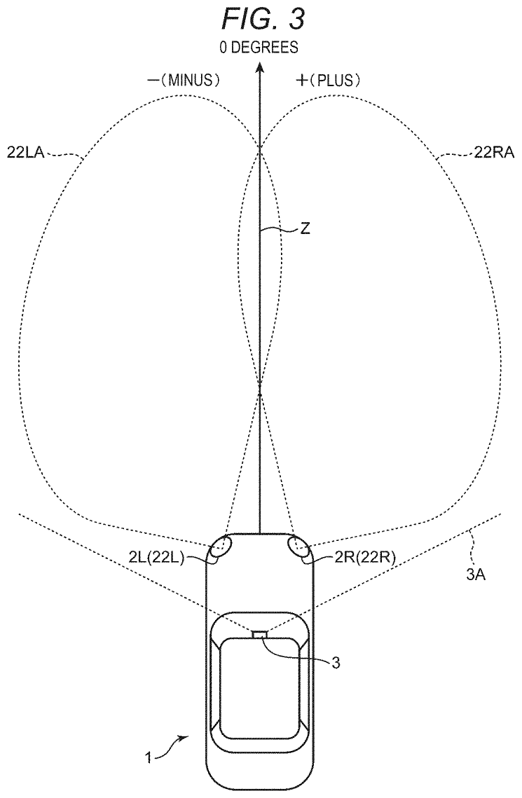

FIG. 3 is a diagram for explaining the light projection ranges of the high beams. The headlight unit 2 includes a right headlight unit 2R and a left headlight unit 2L. The right headlight unit 2R is disposed in the vicinity of the right end at the front part of the vehicle body 10. The left headlight unit 2L is disposed in the vicinity of the left end at the front part of the vehicle body 10. The right headlight unit 2R has a right high-beam unit 22R. The left headlight unit 2L has a left high-beam unit 22L. FIG. 3 schematically shows a right high-beam projection range 22RA of the right high-beam unit 22R and a left high-beam projection range 22LA of the left high-beam unit 22L.

FIG. 3 specifies an axis Z along a traveling line of the vehicle 1 that advances straightly, and FIG. 3 defines the angle of the axis Z as 0 degrees, the direction for turning the axis Z to the right around the vehicle 1 as a plus direction, and the direction for turning the axis Z to the left around the vehicle 1 as a minus direction.

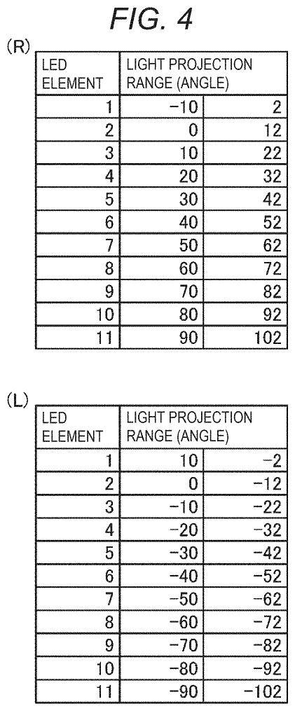

FIG. 4R is a diagram for illustrating the light projection range of each of the LED elements 23A constituting the LED array 23 of the right high-beam unit 22R. FIG. 4L is a diagram for illustrating the light projection range of each of the LED elements 23A constituting the LED array 23 of the left high-beam unit 22L. The light projection range of each of the LED elements 23A is specified by using angles of right and left outer edges of a beam relative to the axis Z at 0 degrees.

For example, it is shown that, in the LED element 23A with the package number 1 of the right high-beam unit 22R, the left outer edge of the beam is −10 degrees relative to the axis Z, and the right outer edge of the beam is +2 degrees relative to the axis Z, that is, a range from −10 to +2 degrees is the light projection range of this LED element 23A. In another example, it is shown that, in the LED element 23A with the package number 1 of the left high-beam unit 22L, the left outer edge of the beam is −2 degrees relative to the axis Z, and the right outer edge of the beam is +10 degrees relative to the axis Z, that is, a range from −2 to +10 degrees is the light projection range of this LED element 23A. Thus, the light projection range of the LED element 23A with the package number 1 of the right high-beam unit 22R and the light projection range of the LED element 23A with the package number 1 of the left high-beam unit 22L partially overlap. As a result, with reference to FIG. 3, the right high-beam projection range 22RA and the left high-beam projection range 22LA partially overlap. Moreover, as shown in FIGS. 4R and 4L, in each of the right high-beam unit 22R and the left high-beam unit 22L, the light projection ranges of adjacent two LED elements 23A partially overlap.

With reference to FIGS. 3, 4R, and 4L, the right high-beam projection range 22RA is a composite of the light projection ranges of the respective eleven LED elements 23A of the right high-beam unit 22R. Thus, the right high-beam projection range 22RA is from −10 to +102 degrees relative to the axis Z. Similarly, the left high-beam projection range 22LA is a composite of the light projection ranges of the respective eleven LED elements 23A of the left high-beam unit 22L and is from −102 to +10 degrees relative to the axis Z.

In each of the right high-beam unit 22R and the left high-beam unit 22L, it is possible to perform control in such a manner as to turn off only one or multiple specific LED elements 23A among the eleven LED elements 23A and turn on the rest of the LED elements 23A. This control is hereinafter called “light reduction control”. For example, in the left high-beam unit 22L, upon execution of light reduction control for turning off only the LED element 23A with the package number 5 and turning on the rest of the LED elements 23A, a left high-beam projection range 22LA is obtained by reducing only light in the range from −42 to −30 degrees in the left high-beam projection range 22LA from −102 to +10 degrees.

### [Configuration of Light Projection System]

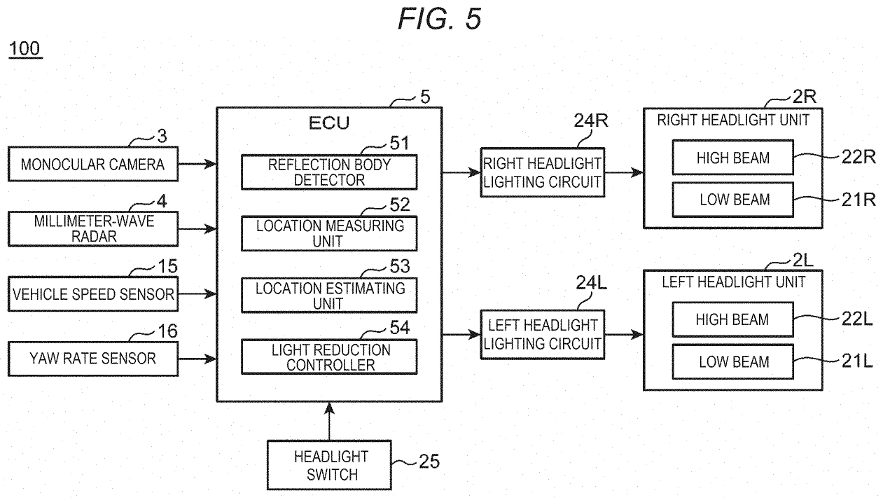

FIG. 5 is a block diagram showing a configuration of a vehicle light-projection system 100 according to an embodiment of the disclosure. As shown by the connection relationship in FIG. 5, the light projection system 100 includes the monocular camera 3, the millimeter-wave radar 4, a vehicle speed sensor 15, a yaw rate sensor 16, the ECU 5, a headlight lighting circuit 24 composed of a right headlight lighting circuit 24R and a left headlight lighting circuit 24L, the headlight unit 2 composed of the right headlight unit 2R and the left headlight unit 2L, and a headlight switch 25.

The right headlight unit 2R includes a right low-beam unit 21R and the right high-beam unit 22R. The left headlight unit 2L includes a left low-beam unit 21L and the left high-beam unit 22L.

The headlight lighting circuit 24 generates a drive signal for turning on the LED light source of the low beam unit 21 on the basis of a lighting control signal input from the ECU 5. The low beam unit 21 drives the LED light source on the basis of the drive signal input from the headlight lighting circuit 24, to project a low beam. The headlight lighting circuit 24 also generates a drive signal for turning on each of the LED elements 23A of the high beam unit 22 on the basis of a lighting control signal input from the ECU 5. The high beam unit 22 drives each of the LED elements 23A on the basis of the drive signal input from the headlight lighting circuit 24, to project a high beam.

The headlight switch 25 receives operation performed by a driver of the vehicle 1, relating to selection of turning on or off the headlight and selection of the high beam or the low beam in the case of turning on the headlight. The headlight switch 25 generates a control signal for turning on or off each of the low beam unit 21 and the high beam unit 22 in accordance with the content of the received operation and inputs this control signal to the ECU 5. In a case in which the vehicle 1 is equipped with a function of automatically controlling turning on and off the headlight unit 2 on the basis of a measured value of illuminance of the surroundings of the vehicle 1 and a function of automatically controlling switching between the high beam and the low beam on the basis of result of detection, such as of a pedestrian or an oncoming vehicle, the headlight switch 25 is substituted with a specific detection circuit and a specific control circuit for executing these functions.

### [Configuration of Light Projection Controlling Device]

With reference to FIG. 5, the ECU 5 functioning as the vehicle light-projection controlling device includes a data processing unit, such as a processor, and a data storage, such as a ROM or a RAM. The data processing unit executes a specific control program that is stored in the data storage, whereby the ECU 5 functions as a reflection body detector 51, a location measuring unit 52, a location estimating unit 53, and a light reduction controller 54.

The reflection body detector 51 detects a reflection body by using a freely selected known detection algorithm in a case in which a reflection body having a brightness value of a predetermined threshold or greater is contained in an image input from the monocular camera 3 to the ECU 5. In one example, the reflection body detector 51 utilizes a characteristic that a luminous body has high brightness only in a small number of pixels at a center part and has low brightness in a large number of pixels at a peripheral edge part, and the reflection body detector 51 detects a reflection body by distinguishing from a luminous body, with the use of the following detection algorithm.

First, the reflection body detector 51 compares a brightness value of each pixel constituting one frame of images, with a predetermined threshold, to determine an image region where multiple pixels having brightness values of the threshold or greater aggregate. Next, the reflection body detector 51 determines whether the image region is a high brightness region due to a luminous body or is a high brightness region due to a reflection body. For example, a frequency distribution showing a relationship between a brightness value and a number of pixels is generated with respect to the image region. In the case in which the frequency distribution has a tendency that the number of pixels decreases as the brightness value increases, this image region is determined as being a high brightness region due to a luminous body. On the other hand, in the case in which the frequency distribution does not have this tendency, the reflection body detector 51 determines this image region as a high brightness region due to a reflection body and detects a target corresponding to this high brightness region as a reflection body.

The location measuring unit 52 or a measuring unit measures a reference location that is a relative location of the reflection body that is detected by the reflection body detector 51, relative to the vehicle 1. For example, the location measuring unit 52 measures a first location that is a location of the reflection body relative to the location of the vehicle 1, in terms of distance and angle, as the reference location.

In a first example, the location measuring unit 52 measures the first location of the reflection body on the basis of image data input from the monocular camera 3 to the ECU 5. First, the location measuring unit 52 determines an image region that is detected as a reflection body by the reflection body detector 51, in one frame of the images input from the monocular camera 3. Next, the location measuring unit 52 calculates a distance from the vehicle 1 to the reflection body by using a freely selected known distance measurement algorithm. For example, first, the location measuring unit 52 utilizes a characteristic that shapes of blurring in front and rear of a focusing position differ from each other, and the location measuring unit 52 finds a focusing position by performing pattern matching on multiple shapes of blurring contained in the image region of the reflection body, with the use of a reference pattern. Then, the location measuring unit 52 calculates a distance from the vehicle 1 to the reflection body on the basis of the distance to the found focusing position. Thereafter, the location measuring unit 52 calculates an angle of the location of the reflection body relative to the location of the vehicle 1 on the basis of the calculated distance to the reflection body and a separation amount of the location of the reflection body from the center in the image.

In a second example, the location measuring unit 52 measures the first location of the reflection body on the basis of reception data of a reflected wave input from the millimeter-wave radar 4 to the ECU 5. First, the location measuring unit 52 extracts reception data corresponding to the location of the reflection body detected by the reflection body detector 51, among the reception data input from the millimeter-wave radar 4. Next, the location measuring unit 52 measures a distance and an angle of the location of the reflection body relative to the location of the vehicle 1 on the basis of the extracted reception data.

The first example and the second example may be performed together, and in this case, the location measuring unit 52 measures the first location of the reflection body on the basis of image data input from the monocular camera 3 and reception data of a reflected wave input from the millimeter-wave radar 4. This increases accuracy of measuring the first location.

The location estimating unit 53 or an estimating unit estimates a relative location of the reflection body relative to the vehicle 1, along a predicted path of the vehicle 1 that advances. For example, the location estimating unit 53 estimates a second location that is a relative location of the reflection body relative to the vehicle 1 that advances, in terms of distance and angle, on the basis of the location information relating to the first location measured by the location measuring unit 52 and advancing information of the vehicle 1. In an example of this embodiment, the advancing information includes vehicle speed information input from the vehicle speed sensor 15 to the ECU 5 and yaw rate information input from the yaw rate sensor 16 to the ECU 5.

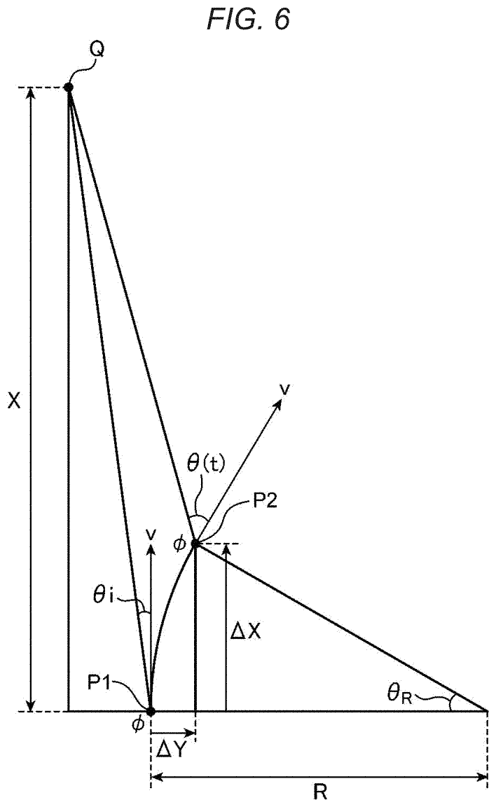

FIG. 6 is a diagram for explaining an estimating method of the second location performed by the location estimating unit 53. A point Q represents a location of a reflection body. A point P1 represents a location of the vehicle 1 at the time the location measuring unit 52 detects the reflection body, and the point P1 corresponds to the first location. Assuming that the longitudinal direction of the paper surface is an X-axis direction and the lateral direction of the paper surface is a Y-axis direction, a distance between the points Q and P1 in the X-axis direction is a distance X (m). The vehicle 1 is assumed to move at a constant speed v (m/s) and a constant yaw rate φ (rad/s). The direction of the arrow indicating the speed v is a front direction of the vehicle 1 at the point P1, and therefore, an angle of the reflection body relative to the vehicle 1 at the first location is an angle θi (rad). A point P2 is a location of the vehicle 1 when the vehicle 1 moves for time t (s) from the location of the point P1, and the point P2 corresponds to the second location. The travel amounts of the vehicle 1 from the point P1 to the point P2 are ΔX (m) in the X-axis direction and ΔY (m) in the Y-axis direction.

A curvature radius R and a central angle θ_{R} of the traveling path of the vehicle 1 that travels from the point P1 to the point P2 are respectively represented by the following formulas (1) and (2).

$$\begin{matrix}[ Equation 1 ] & \\ R [ m ] = \frac{v [ m \text{/} s ]}{ϕ [ rad \text{/} s ]} & ( 1 ) \\ [ Equation 2 ] & \\ {θ}_{R} [ rad ] = ϕ t & ( 2 )\end{matrix}$$

Thus, the travel amounts ΔX and ΔY are represented by the following formula (3).

$$\begin{matrix}[ Equation 3 ] & \\ Δ X = v t sin ( \frac{π - ϕ t}{2} ) = v t cos ( \frac{ϕ t}{2} ) \\ Δ Y = v t cos ( \frac{π - ϕ t}{2} ) = v t sin ( \frac{ϕ t}{2} ) & ( 3 )\end{matrix}$$

As a result, in a case in which both of the speed v and the yaw rate φ are constant, an angle θ(t) is represented by the following formula (4).

$$\begin{matrix}[ Equation 4 ] & \\ θ ( t ) = arctan ( \frac{X sin {θ}_{i} + v t sin ( \frac{ϕ t}{2} )}{X - v t cos ( \frac{ϕ t}{2} )} ) + ϕ t & ( 4 )\end{matrix}$$

In a case in which the speed v and the yaw rate φ vary with time, these parameters are presumed to be time functions and are integrated by time t, and thus, the angle θ(t) is represented by the following formula (5).

$$\begin{matrix}[ Equation 5 ] & \\ \int θ ( t ) d t = \int \{ arctan ( \frac{X sin {θ}_{i} + v sin ( \frac{ϕ}{2} )}{X - v cos ( \frac{ϕ}{2} )} ) + ϕ \} d t & ( 5 )\end{matrix}$$

In the case in which the vehicle 1 moves straightly, the value of the yaw rate p is set to 0 in the formula (4) or (5).

The location estimating unit 53 estimates an angle θ(t) of the reflection body relative to each location of the vehicle 1 that advances, that is, each time t, by arithmetic operation using the formula (4) or (5). Moreover, the location estimating unit 53 estimates a distance between each location of the vehicle 1 that advances and the reflection body, as an approximation of a difference between the distance X and the travel amount ΔX. Alternatively, the location estimating unit 53 may exactly estimate the distance between each location of the vehicle 1 that advances and the reflection body by calculating a distance between the points P2 and Q with the use of a trigonometric function.

With reference to FIG. 5, the light reduction controller 54 or a light reduction controlling unit performs light reduction control on the high beam unit 22 so as to reduce light to be projected to a range corresponding to the second location estimated by the location estimating unit 53, in the high beam projection ranges 22RA and 22LA of the high beam unit 22. That is, in response to estimation of the second location by the location estimating unit 53, the light reduction controller 54 specifies one or multiple LED elements 23A that have illumination ranges containing the second location, among all of the LED elements 23A provided to the high beam unit 22, and the light reduction controller 54 turns off the specified LED element 23A. The second location changes in accordance with advance of the vehicle 1, and therefore, the light reduction controller 54 updates information of the LED element 23A to be turned off by following the change of the second location.

Turning off the LED element 23A corresponding to the second location by the light reduction control reduces the intensity of the high beam emitted to the reflection body, whereby the intensity of reflection light that is reflected back from the reflection body is also reduced. Thus, prevention of glare for a driver of the vehicle 1 is achieved. On the other hand, in the photographic image taken by the monocular camera 3 after the light reduction control is started, brightness of the reflection body is decreased, compared with the image prior to start of the light reduction control. This makes the monocular camera 3 lose sight of the reflection body, and thus, it is difficult or impossible to track the reflection body on the basis of the photographic image taken by the monocular camera 3 after the light reduction control is started. In this regard, in the ECU 5 of this embodiment, the location estimating unit 53 tracks and estimates the second location that changes, and the light reduction controller 54 performs the light reduction control by following the change of the second location, whereby the antiglare effect on a driver of the vehicle 1 continues even when the monocular camera 3 loses sight of the reflection body.

### [Processing Flow of Light Projection Controlling Device]

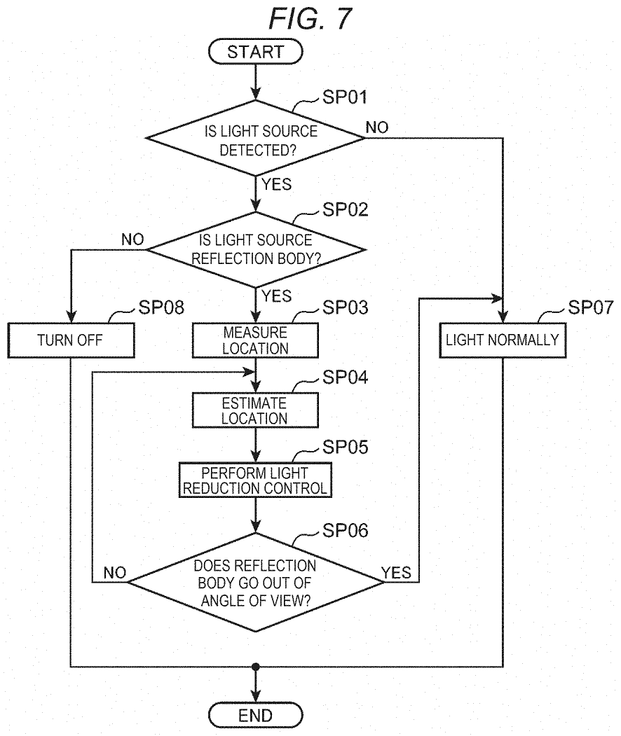

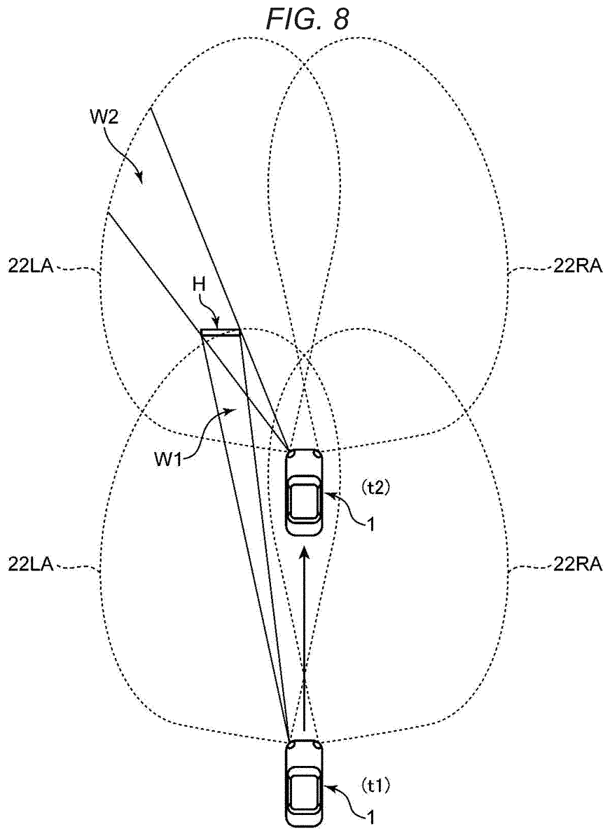

FIG. 7 is a flowchart showing a flow of processing executed by the ECU 5 in a situation in which a lighting control signal of the high beam is input from the headlight switch 25 to the ECU 5 to light the high beam normally. The normal lighting of the high beam is a state in which all of the LED elements 23A of the high beam unit 22 are turned on. The ECU 5 repeatedly executes the processing shown in FIG. 7 at a predetermined time interval while the high beam is lighted normally.

First, in step SP01, the reflection body detector 51 determines whether a light source is contained in an image input from the monocular camera 3. For example, the reflection body detector 51 compares a brightness value of each pixel constituting one frame of images, with a predetermined threshold, to determine whether an image region where multiple pixels having brightness values of the threshold or greater aggregate, that is, a high brightness region, is contained in the frame. The reflection body detector 51 determines that a light source is detected in the case in which such a high brightness region is contained in the frame, and the reflection body detector 51 determines that a light source is not detected in the case in which such a high brightness region is not contained.

In the case in which a light source is not contained in the image (step SP01: NO), next, in step SP07, the ECU 5 maintains the normal lighting state of the high beam. That is, the ECU 5 inputs the lighting control signal of the high beam to the headlight lighting circuit 24, the headlight lighting circuit 24 generates a drive signal for lighting all of the LED elements 23A, and the high beam unit 22 drives all of the LED elements 23A on the basis of the drive signal. Thus, the high beam is projected from the high beam unit 22.

On the other hand, in the case in which a light source is contained in the image (step SP01: YES), next, in step SP02, the reflection body detector 51 determines whether the light source is a reflection body. As described above, the reflection body detector 51 determines the light source as a luminous body in the case in which the image region detected in step SP01 is a high brightness region due to the luminous body, and, on the other hand, the reflection body detector 51 determines the light source as a reflection body in the case in which the image region detected in step SP01 is a high brightness region due to the reflection body.

In the case in which the light source is a luminous body (step SP02: NO), next, in step SP08, the ECU 5 turns off the high beam unit 22 but turns on the low beam unit 21 to switch the high beam to the low beam.

On the other hand, in the case in which the light source is a reflection body (step SP02: YES), next, in step SP03, the location measuring unit 52 measures a first location of the reflection body that is detected in step SP02, relative to the vehicle 1. As described above, the location measuring unit 52 measures the first location of the reflection body on the basis of one or both of image data input from the monocular camera 3 to the ECU 5 and reception data of a reflected wave input from the millimeter-wave radar 4 to the ECU 5.

Next, in step SP04, the location estimating unit 53 estimates a second location that is a relative location of the reflection body relative to the vehicle 1 that advances. As described above, the location estimating unit 53 estimates the second location on the basis of the location information relating to the first location measured in step SP03 and the advancing information of the vehicle 1.

Next, in step SP05, the light reduction controller 54 performs the light reduction control on the high beam unit 22 with respect to the second location estimated in step SP04. As described above, the light reduction controller 54 specifies one or multiple LED elements 23A that have illumination ranges containing the second location, among all of the LED elements 23A provided to the high beam unit 22, and the light reduction controller 54 turns off the specified LED element 23A. The second location changes in accordance with advance of the vehicle 1, and therefore, the light reduction controller 54 updates information of the LED element 23A to be turned off by following the change of the second location.

FIG. 8 schematically shows an example of a situation in which the light reduction control of the high beam is executed. FIG. 8 shows a situation in which the road sign H as a reflection body exists left forward of the vehicle 1 that advances. The road sign H is located in a range approximately from −20 to −15 degrees relative to the vehicle 1 at time t1. In this case, the light reduction controller 54 turns off the LED element 23A with the package number 3 of the left high-beam unit 22L but turns on the rest of the LED elements 23A. Thus, a light reduced region W1 containing the location of the road sign H is formed in the left high-beam projection range 22LA.

As a result of advance of the vehicle 1, the road sign H is located in a range approximately from −50 to −35 degrees relative to the vehicle 1 at time t2 after a predetermined time elapses from the time t1. In this state, the light reduction controller 54 turns off the LED elements 23A with the package numbers 5 and 6 of the left high-beam unit 22L but turns on the rest of the LED elements 23A. Thus, a light reduced region W2 containing the location of the road sign H is formed in the left high-beam projection range 22LA.

With reference to FIG. 7, in step SP06 subsequently to step SP05, the light reduction controller 54 determines whether the reflection body goes out of an angle of view 3A of the monocular camera 3 in accordance with advance of the vehicle 1. As shown in FIG. 3, the monocular camera 3 has the angle of view 3A corresponding to the photographable range. The value of the outermost angle of the angle of view 3A of the monocular camera 3 is preliminarily input to the ECU 5 as angle information relative to the axis Z. For example, in a case in which a monocular camera 3 having an angle of view 3A of 170 degrees is used, the value of the outermost angle in the left direction of −85 degrees and the value of the outermost angle in the right direction of +85 degrees are preliminarily input to the ECU 5 as angle of view information. The light reduction controller 54 determines that the reflection body goes out of the angle of view 3A of the monocular camera 3 in the case in which the angle θ(t) that is estimated by arithmetic operation using the formula (4) or (5) exceeds either one of the values of the outermost right and left angles.

In the case in which the reflection body does not go out of the angle of view 3A (step SP06: NO), the ECU 5 repeats the processing from step SP04 to step SP06.

On the other hand, in the case in which the reflection body goes out of the angle of view 3A (step SP06: YES), next, in step SP07, the ECU 5 cancels the light reduction control of the high beam unit 22 and resumes the normal lighting.

The above describes an example in which the ECU 5 executes the light reduction control of the high beam in a situation that the headlight unit 2 projects the high beam. However, the embodiment is not limited to this example. The ECU 5 may execute the light reduction control of the low beam in a situation in which the headlight unit 2 projects the low beam.

### [Operation and Effect]

In the ECU 5 of this embodiment, the location measuring unit 52 measures a first location or a reference location that is a relative location of a reflection body relative to the vehicle 1 at the time the reflection body is detected, in the case in which the reflection body having a predetermined brightness value or greater is contained in an image that is obtained by photographing in the advancing direction of the vehicle 1. Moreover, the location estimating unit 53 estimates a second location that is a relative location of the reflection body relative to the vehicle 1 that advances, on the basis of the location information relating to the first location and the advancing information of the vehicle 1. Thereafter, the light reduction controller 54 performs the light reduction control on the headlight unit 2 so as to reduce light to be projected to a range corresponding to the second location, in the light projection range of the headlight unit 2. Thus, even when a high brightness region corresponding to the reflection body is not contained in the photographic image due to the light reduction control, estimation of the second location by the location estimating unit 53 enables the light reduction controller 54 to continue the light reduction control with respect to the second location, instead of canceling the light reduction control. This results in enhancement of the antiglare effect on a driver of the vehicle 1 in the case in which a reflection body having a predetermined brightness value or greater is contained in the light projection range of the headlight unit 2 mounted on the vehicle 1.

In the ECU 5 of this embodiment, the light reduction controller 54 continues the light reduction control until the second location goes out of the photographing range in the advancing direction of the vehicle 1. Thus, the light reduction control is not canceled until the second location goes out of the photographing range, whereby the antiglare effect on a driver of the vehicle 1 is enhanced. In other words, the light reduction control is canceled after the second location goes out of the photographing range in accordance with advance of the vehicle 1, and at this time, the reflection body already goes out of the photographing range and also goes sufficiently away from the central visual field of the driver who looks in the advancing direction of the vehicle 1. This prevents the driver from feeling glare due to reflection light that is reflected back from the reflection body, although the light reduction control is canceled, and therefore, the antiglare effect on the driver is enhanced. Moreover, the photographing range is clearly specified by the angle of view of the monocular camera 3, whereby the timing for the light reduction controller 54 to cancel the light reduction control is clearly and simply specified.

In the ECU 5 of this embodiment, the location estimating unit 53 estimates the second location on the basis of the location information relating to the first location and the speed information of the vehicle 1. Use of the speed information of the vehicle 1 enables appropriately estimating the second location relative to the vehicle 1 that travels a straight road.

In the ECU 5 of this embodiment, the location estimating unit 53 estimates the second location on the basis of the location information relating to the first location, the speed information of the vehicle 1, and the yaw rate information of the vehicle 1. Use of the speed information and the yaw rate information of the vehicle 1 enables appropriately estimating the second location relative to the vehicle 1 that travels a curve as well as a straight road.

### First Modification Example

In the foregoing embodiment, the light reduction controller 54 continues the light reduction control of the high beam unit 22 until the second location goes out of the photographing range or the angle of view 3A in the advancing direction of the vehicle 1. The embodiment is not limited to this example, and the light reduction controller 54 may continue the light reduction control of the high beam unit 22 until the second location goes out of the light projection range of the high beam unit 22.

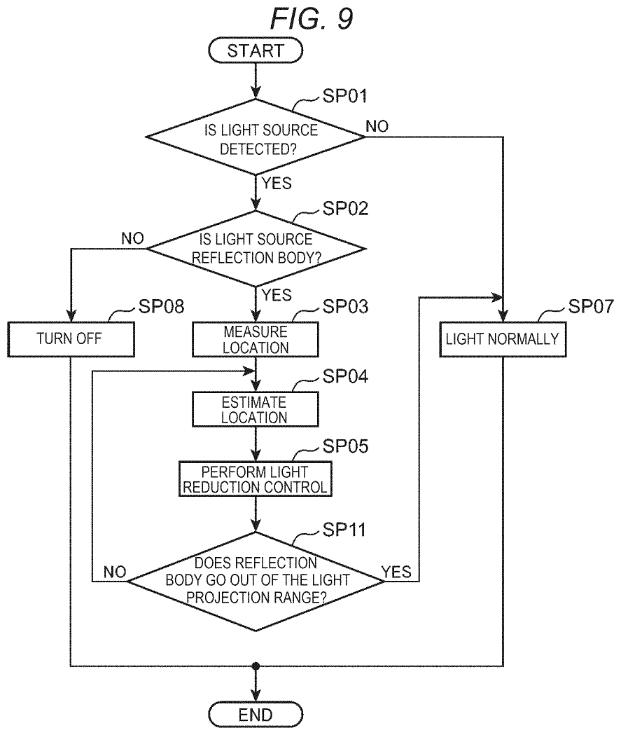

FIG. 9 is a flowchart showing a flow of processing executed by the ECU 5 in the first modification example. In step SP11 subsequently to step SP05, the light reduction controller 54 determines whether the reflection body goes out of the light projection range of the high beam unit 22 in accordance with advance of the vehicle 1. As shown in FIGS. 4R and 4L, the right high-beam projection range 22RA is from −10 to +102 degrees relative to the axis Z, whereas the left high-beam projection range 22LA is from −102 to +10 degrees relative to the axis Z.

The right high-beam projection range 22RA and the left high-beam projection range 22LA are preliminarily input to the light reduction controller 54 as angle information relative to the axis Z. The light reduction controller 54 determines that a reflection body goes out of the light projection range of the high beam unit 22 in the case in which the angle θ(t) that is estimated by arithmetic operation using the formula (4) or (5) exceeds either one of the values of the outermost angles of the right high-beam projection range 22RA and the left high-beam projection range 22LA, which are +102 degrees and −102 degrees.

In the case in which the reflection body does not go out of the light projection range (step SP11: NO), the ECU 5 repeats the processing in steps SP04, SP05, and SP11. On the other hand, in the case in which the reflection body goes out of the light projection range (step SP11: YES), next, in step SP07, the ECU 5 cancels the light reduction control of the high beam unit 22 and resumes the normal lighting.

In the ECU 5 of this modification example, the light reduction controller 54 continues the light reduction control until the second location goes out of the light projection range of the high beam unit 22. Thus, the light reduction control is not canceled until the second location goes out of the light projection range of the high beam unit 22, whereby the antiglare effect on a driver of the vehicle 1 is enhanced. In other words, the light reduction control is canceled after the second location goes out of the light projection range of the high beam unit 22 in accordance with advance of the vehicle 1, and at this time, the reflection body already goes out of the light projection range of the high beam unit 22 and also goes sufficiently away from the central visual field of the driver who looks in the advancing direction of the vehicle 1. This prevents the driver from feeling glare due to reflection light that is reflected back from the reflection body, although the light reduction control is canceled, and therefore, the antiglare effect on the driver is enhanced.

### Second Modification Example

In the foregoing embodiment, the location measuring unit 52 measures the first location of the reflection body on the basis of one or both of the image data input from the monocular camera 3 to the ECU 5 and the reception data of a reflected wave input from the millimeter-wave radar 4 to the ECU 5. The embodiment is not limited to this example, and the location measuring unit 52 may measure the first location on the basis of map information in which the placed location of the reflection body is registered and location information showing a current location of the vehicle 1, instead of or in addition to the above-described data.

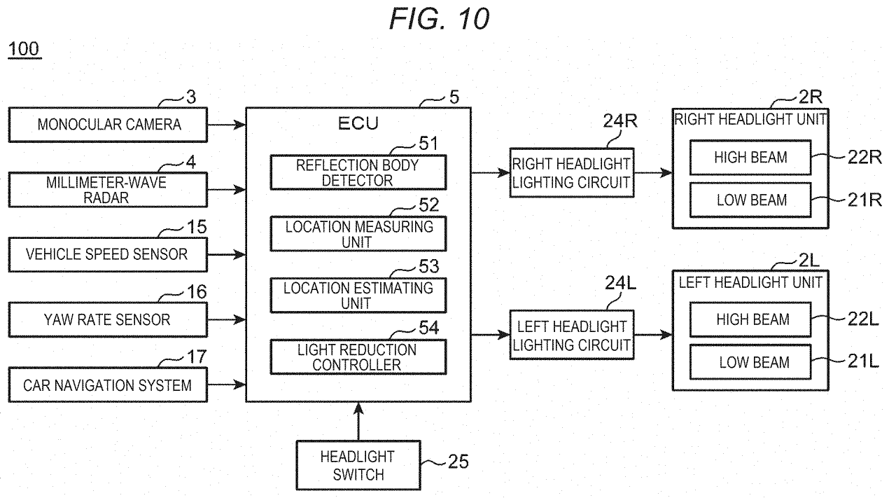

FIG. 10 is a block diagram showing a configuration of the vehicle light-projection system 100 according to the second modification example. The light projection system 100 includes a car navigation system 17 in addition to the components shown in FIG. 5. The car navigation system 17 inputs map information and location information to the ECU 5. In the map information, a placed location of, e.g., the road sign H as a reflection body is registered. The location information shows a current location of the vehicle 1, such as a current location from a GPS.

The location measuring unit 52 measures the first location of the reflection body on the basis of the map information and the location information.

In the ECU 5 of this modification example, the location measuring unit 52 measures the first location on the basis of the map information in which the placed location of the reflection body is registered and the location information showing a current location of the vehicle 1. Use of these pieces of information enables exactly measuring the first location of the reflection body.

In the foregoing embodiment, the location estimating unit 53 estimates the second location on the basis of the location information relating to the first location and the advancing information, that is, the vehicle speed information and the yaw rate information, of the vehicle 1. The embodiment is not limited to this example, and the location estimating unit 53 may estimate the second location on the basis of the map information in which the placed location of the reflection body is registered and the location information showing a current location of the vehicle 1, in addition to the above-described pieces of information.

With reference to FIG. 10, the location estimating unit 53 estimates the second location on the basis of the location information relating to the first location measured by the location measuring unit 52, the advancing information, that is, the vehicle speed information and the yaw rate information, of the vehicle 1, and the map information and the location information input from the car navigation system 17.

In the ECU 5 of this modification example, the location estimating unit 53 estimates the second location on the basis of the location information relating to the first location, the advancing information of the vehicle 1, the map information in which the placed location of the reflection body is registered, and the location information showing a current location of the vehicle 1. Use of the map information in which the placed location of the reflection body is registered and the location information showing a current location of the vehicle 1 enables exactly estimating the second location.

### Third Modification Example

In the foregoing embodiment, the light reduction controller 54 performs the light reduction control on the high beam unit 22 so as to turn off the LED element 23A corresponding to the second location. The embodiment is not limited to this example, and the light reduction controller 54 may reduce the amount of illumination light of the LED element 23A, instead of turning off the LED element 23A corresponding to the second location. At this time, the light reduction controller 54 may vary the reduction degree of the amount of illumination light, that is, the degree of light reduction, of the LED element 23A.

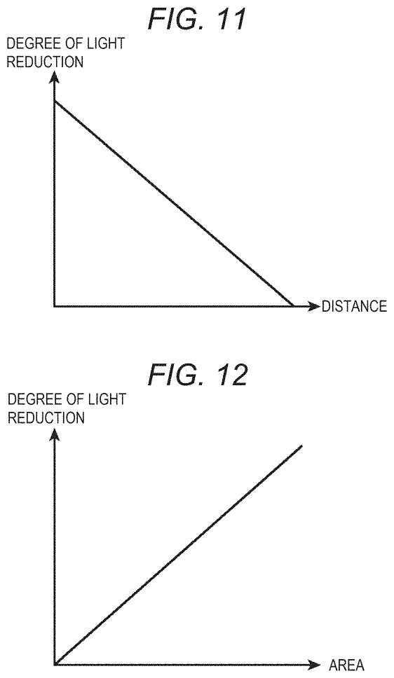

FIG. 11 is a diagram showing an example of a relationship between a distance and a degree of light reduction. Table information or a function expression in which this relationship is described, is generated in advance and is stored in an internal memory of the ECU 5 or in an external memory that is able to be referred to by the ECU 5. As shown in FIG. 11, the light reduction controller 54 varies the degree of light reduction of the LED element 23A corresponding to the second location, on the basis of a distance between the vehicle 1 at the second location and the reflection body. Specifically, the light reduction controller 54 is set to increase the degree of light reduction of the LED element 23A as the distance between the vehicle 1 at the second location and the reflection body is shorter and thus reduces a large amount of the illumination light of the LED element 23A accordingly.

In the ECU 5 of this modification example, the light reduction controller 54 varies the degree of light reduction of the LED element 23A corresponding to the second location on the basis of the distance between the vehicle 1 and the reflection body. This enables execution of appropriate light reduction control in accordance with the distance between the vehicle 1 and the reflection body, neither too much nor too little.

In the ECU 5 of this modification example, the degree of light reduction of the LED element 23A is set to be greater as the distance between the vehicle 1 and the reflection body is shorter, whereby the antiglare effect due to the light reduction control is enhanced.

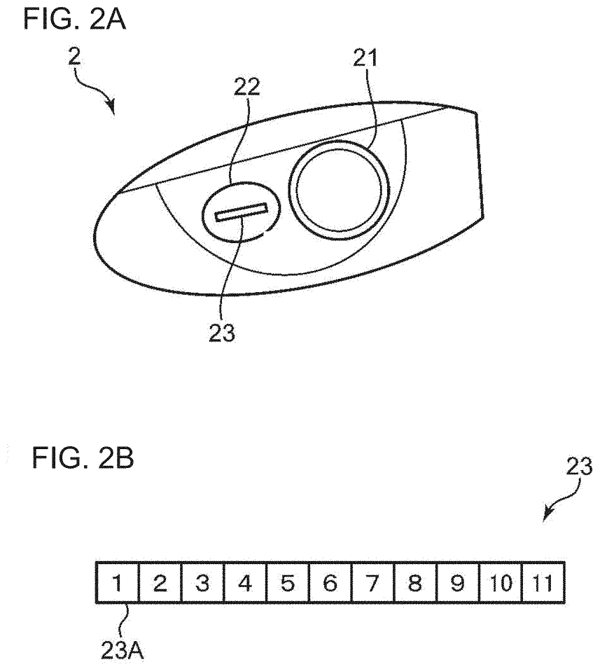

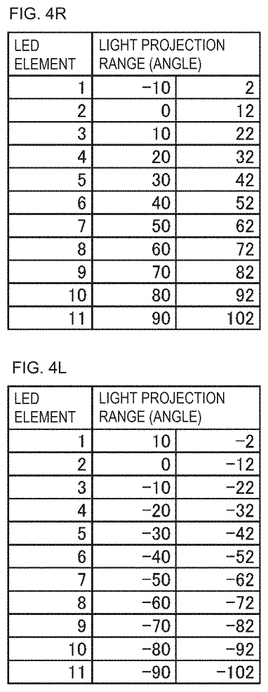

FIG. 12 is a diagram showing an example of a relationship between an area and the degree of light reduction. Table information or a function expression in which this relationship is described, is generated in advance and is stored in an internal memory of the ECU 5 or in an external memory that is able to be referred to by the ECU 5. As shown in FIG. 12, the light reduction controller 54 varies the degree of light reduction of the LED element 23A corresponding to the second location, on the basis of an area of an image region corresponding to the reflection body in the image input from the monocular camera 3. Specifically, the light reduction controller 54 is set to increase the degree of light reduction of the LED element 23A as the area of the image region corresponding to the reflection body is larger and thus reduces a large amount of the illumination light of the LED element 23A accordingly.

In the ECU 5 of this modification example, the light reduction controller 54 varies the degree of light reduction of the LED element 23A corresponding to the second location, on the basis of dimensions of the reflection body, which is the area of the image region corresponding to the reflection body in the above-described example, contained in the image input from the monocular camera 3. This enables execution of appropriate light reduction control in accordance with the dimensions of the reflection body contained in the image, neither too much nor too little.

In the ECU 5 of this modification example, the degree of light reduction of the LED element 23A is set to be greater as the dimensions of the reflection body contained in the image are larger, whereby the antiglare effect due to the light reduction control is enhanced.

What is claimed is:

1. A vehicle light-projection controlling device configured to control a headlight that is mounted on a vehicle, the vehicle light-projection controlling device comprising:
one or more sensors configured to measure a reference location that is a location of a reflection body relative to the vehicle, the reflection body being contained in an image that is obtained by photographing in an advancing direction of the vehicle; and
processing circuitry configured to
estimate a relative location of the reflection body relative to the vehicle that advances, based on location information relating to the reference location and advancing information of the vehicle, and
perform light reduction control on the headlight so as to reduce light to be projected to a range corresponding to the relative location, in a light projection range of the headlight.

2. The vehicle light-projection controlling device according to claim 1, wherein the processing circuitry is further configured to continue the light reduction control until the relative location goes out of a photographing range in the advancing direction of the vehicle.

3. The vehicle light-projection controlling device according to claim 1, wherein the processing circuitry is further configured to continue the light reduction control until the relative location goes out of the light projection range.

4. The vehicle light-projection controlling device according to claim 2, wherein the processing circuitry is further configured to vary a degree of light reduction of the headlight, based on a distance between the vehicle and the reflection body.

5. The vehicle light-projection controlling device according to claim 4, wherein the processing circuitry is further configured to increase the degree of light reduction of the headlight as the distance between the vehicle and the reflection body is shorter.

6. The vehicle light-projection controlling device according to claim 2, wherein the processing circuitry is further configured to vary a degree of light reduction of the headlight, based on dimensions of the reflection body contained in the image.

7. The vehicle light-projection controlling device according to claim 6, wherein the processing circuitry is further configured to increase the degree of light reduction of the headlight as the dimensions of the reflection body contained in the image are larger.

8. The vehicle light-projection controlling device according to claim 5, wherein the advancing information includes speed information.

9. The vehicle light-projection controlling device according to claim 8, wherein the advancing information further includes yaw rate information.

10. The vehicle light-projection controlling device according to claim 9, wherein the one or more sensors are configured to measure the reference location based on map information in which a placed location of the reflection body is registered and location information showing a current location of the vehicle.

11. The vehicle light-projection controlling device according to claim 10, wherein the processing circuitry is further configured to estimate the relative location based on map information in which a placed location of the reflection body is registered and the location information showing a current location of the vehicle.

12. A vehicle light-projection system comprising:
a headlight configured to project light in an advancing direction of a vehicle;
an imaging sensor configured to perform photographing in the advancing direction of the vehicle;
one or more sensors configured to measure advancing information of the vehicle; and
a light projection controller comprising processing circuitry configured to
measure a reference location that is a location of a reflection body relative to the vehicle, the reflection body being contained in an image that is obtained by photographing in the advancing direction of the vehicle,
estimate a relative location of the reflection body relative to the vehicle that advances, based on location information relating to the reference location and the advancing information measured by the one or more sensors, and
perform light reduction control on the headlight so as to reduce light to be projected to a range corresponding to the relative location, in a light projection range of the headlight.

13. A vehicle light-projection controlling method for controlling projection of light in an advancing direction of a vehicle, the vehicle light-projection controlling method comprising:
measuring a reference location that is a location of a reflection body relative to the vehicle, the reflection body being contained in an image that is obtained by photographing in the advancing direction of the vehicle;
estimating a relative location of the reflection body relative to the vehicle that advances, based on location information relating to the reference location and advancing information of the vehicle; and
performing light reduction control so as to reduce light to be projected to a range corresponding to the relative location, in a range of projecting light in the advancing direction of the vehicle.

14. The vehicle light-projection controlling device according to claim 1, wherein the processing circuitry is further configured to vary a degree of light reduction of the headlight, based on a distance between the vehicle and the reflection body.

15. The vehicle light-projection controlling device according to claim 1, wherein the processing circuitry is further configured to vary a degree of light reduction of the headlight, based on dimensions of the reflection body contained in the image.

16. The vehicle light-projection controlling device according to claim 1, wherein the one or more sensors are configured to measure the reference location based on map information in which a placed location of the reflection body is registered and location information showing a current location of the vehicle.

17. The vehicle light-projection controlling device according to claim 1, wherein the processing circuitry is further configured to estimate the relative location based on map information in which a placed location of the reflection body is registered and the location information showing a current location of the vehicle.

18. The vehicle light-projection controlling device according to claim 14, wherein the processing circuitry is further configured to increase the degree of light reduction of the light projecting unit as the distance between the vehicle and the reflection body is shorter.

19. The vehicle light-projection controlling device according to claim 15, wherein the processing circuitry is further configured to increase the degree of light reduction of the headlight as the dimensions of the reflection body contained in the image are larger.

20. The vehicle light-projection controlling device according to claim 17, wherein the processing circuitry is further configured to estimate the relative location based on map information in which a placed location of the reflection body is registered and the location information showing a current location of the vehicle.
